(19) United States
(12) Patent Application Publication
(10) Pub. No.: US 2015/0043737 A1
(43) Pub. Date: Feb. 12, 2015

(54) SOUND DETECTING APPARATUS, SOUND DETECTING METHOD, SOUND FEATURE VALUE DETECTING APPARATUS, SOUND FEATURE VALUE DETECTING METHOD, SOUND SECTION DETECTING APPARATUS, SOUND SECTION DETECTING METHOD, AND PROGRAM

(71) Applicant: SONY CORPORATION, Minato-ku, Tokyo (JP)

(72) Inventors: Mototsugu Abe, Kanagawa (JP); Masayuki Nishiguchi, Kanagawa (JP); Yoshinori Kurata, Ibaraki (JP)

(73) Assignee: SONY CORPORATION, Minato-ku, Tokyo (JP)

(21) Appl. No.: 14/385,856

(22) PCT Filed: Apr. 16, 2013
(86) PCT No.: PCT/JP2013/002581

§ 371 Date: Sep. 17, 2014

(30) Foreign Application Priority Data
Apr. 18, 2012 (JP) 2012-094395

(51) Int. Cl. G10L 25/18; G10L 25/48; G06F 17/30

(52) U.S. Cl. CPC G10L 25/18; G06F 17/30752; G10L 25/48
USPC 381/56

(57) ABSTRACT

There is provided a sound detecting apparatus including: a feature value extracting unit which extracts a feature value per every predetermined time from an input time signal; a feature value maintaining unit which maintains a feature value sequence of a predetermined number of detection target sound items; and a comparison unit which respectively compares a feature value sequence extracted by the feature value extracting unit with a feature value sequence of the maintained predetermined number of detecting target sound items and obtains detection results of the predetermined number of detection target sound items every time the feature value extracting unit newly extracts a feature value, wherein the feature value extracting unit includes a time frequency transform unit and a likelihood distribution detecting unit, smooths the obtained likelihood distribution in frequency and time directions, and extracts a feature value per the predetermined time.

### TECHNICAL FIELD

The present technology relates to a sound detecting apparatus, a sound detecting method, a sound feature value detecting apparatus, a sound feature value detecting method, a sound section detecting apparatus, a sound section detecting method and a program.

### BACKGROUND ART

In recent years, home electrical appliances (electric devices for domestic use) generate various kinds of sound (hereinafter, referred to as “running state sound”) such as control sounds, notification sounds, operating sounds, and alarm sounds in accordance with running state. If it is possible to observe such running state sounds by a microphone or the like installed at a certain place at home and detect when and which home electrical appliance performs what kind of operation, various application functions such as automatic collection of self action history, which is a so-called life log, visualization of notification sounds for people with hearing difficulties, and action monitoring for aged people who live alone can be realized.

The running state sound may be a simple buzzer sound, beep sound, music, voice sound, or the like, and a continuation time length is about 300 ms in a case of a short continuation time length and about several tens of seconds in a case of a long continuation time length. Such running state sound is reproduced by a reproduction device, sound from which is not sufficiently satisfactory, such as a piezoelectric buzzer or a thin speaker mounted on each home electrical appliance, and is made to propagate in the surroundings.

For example, PTL 1 discloses a technology in which partial fragmented data of a music composition is transformed into a time frequency distribution, a feature value is extracted and then compared with a feature value of a music composition, which has already been registered, and a name of the music composition is identified.

### CITATION LIST

### Patent Literature

PTL 1: Japanese Patent No. 4788810

### SUMMARY OF INVENTION

### Technical Problem

It can be also considered that the same technology as that disclosed in PTL 1 is applied to detection of the aforementioned running state sound. In relation to the running state sound generated by home electrical appliances, however, the following facts that hinder such detection are present.

(1) It is necessary to recognize running state sound which is as short as several hundred milliseconds.

(2) Due to poor quality of a reproduction device, sound becomes distorted, or resonance occurs and in some cases frequency characteristics are extremely distorted.

(3) Amplitude and phase frequency characteristics are further distorted compared with sound generated by an actual domestic electrical appliance, due to propagation in the surroundings.

For example, FIG. 17A shows an example of a waveform of running state sound recorded at a position which is close to a domestic electrical appliance. On the other hand, FIG. 17B shows an example of a waveform of running state sound recorded at a position which is distant from the domestic electrical appliance, and the waveform is distorted.

(4) Relatively large noise and non-constant noise such as output sound from a television and conversation sound are superimposed in some cases due to propagation in the surroundings. For example, FIG. 17C shows an example of a waveform of running state sound recorded at a position which is close to a television as a noise source, and the running state sound is buried in noise.

(5) Since a level of sound from each domestic electrical appliance and distance to the microphone depends on each home electrical appliance, the volume of recorded sound varies.

It is desired to satisfactorily detect detection target sound such as running state sound generated from a home electrical appliance.

### Solution to Problem

An embodiment of the present technology relates to a sound detecting apparatus including: a feature value extracting unit which extracts a feature value per every predetermined time from an input time signal; a feature value maintaining unit which maintains a feature value sequence of a predetermined number of detection target sound items; and a comparison unit which respectively compares a feature value sequence extracted by the feature value extracting unit with a feature value sequence of the maintained predetermined number of detecting target sound items and obtains detection results of the predetermined number of detection target sound items every time the feature value extracting unit newly extracts a feature value, wherein the feature value extracting unit includes a time frequency transform unit which performs time frequency transform on the input time signal for each time frame and obtains time frequency distribution, a likelihood distribution detecting unit which obtains tone likelihood distribution from the time frequency distribution, and a smoothing unit which smooths the likelihood distribution in a frequency direction and a time direction, and extracts the feature value per the predetermined time from the smoothed likelihood distribution.

According to the present technology, the feature value extracting unit extracts the feature value per the predetermined time from the input time signal. In such a case, the feature value extracting unit performs time frequency transform on the input signal for each time frame, obtains the time frequency distribution, obtains tone likelihood distribution from the time frequency distribution, smooths the likelihood distribution in the frequency direction and the time direction, and extracts the feature value per the predetermined time from the smoothed likelihood distribution.

For example, the likelihood distribution detecting unit may include a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result.

The feature value maintaining unit maintains a feature value sequence of the predetermined number of detection target sound items. The detection target sound can include voice sound of a person or an animal or the like as well as running state sound generated from a domestic electrical appliance (control sounds, notification sounds, operating sounds, alarm sounds, and the like). Every time the feature value extracting unit newly extracts a feature value, the comparison unit respectively compares the feature value sequence extracted by the feature value extracting unit with the feature value sequence of the maintained predetermined number of detection target sound and obtains the detection results of the predetermined number of detection target sound items.

For example, the comparison unit may obtain similarity based on correlation between corresponding feature values between the feature value sequence of the maintained detection target sound items and the feature value sequence extracted by the feature value extracting unit for each of the predetermined number of detection target sound items and obtain the detection results of the detection target sound items based on the obtained similarity.

According to the present technology, the tone likelihood is obtained from the time frequency distribution of the input time signal, the feature value per every predetermined time is extracted and used from the likelihood distribution which has been smoothed in the frequency direction and the time direction, and it is possible to precisely detect detection target sound (running state sound and the like generated from a domestic electrical appliance) without depending on an installation position of the microphone.

According to the present technology, for example, the feature value extracting unit may further include a thinning unit which thins the smoothed likelihood distribution in the frequency direction and/or the time direction. According to the present technology, for example, the feature value extracting unit may further include a quantizing unit which quantizes the smoothed likelihood distribution. In such a case, it is possible to reduce the data amount of the feature value sequence and to thereby reduce burden of the comparison computation.

According to the present technology, for example, the apparatus may further include a recording control unit which records the detection results of the predetermined number of detection target sound items along with time information on a recording medium. In such a case, for example, it is possible to obtain a user action history at home such as an operation history of a domestic electrical appliance.

Another concept of the present technology relates to a sound feature value extracting apparatus including: a time frequency transform unit which performs time frequency transform on an input time signal for each time frame and obtains time frequency distribution; a likelihood distribution detecting unit which obtains tone likelihood distribution from the time frequency distribution; and a feature value extracting unit which smooths the likelihood distribution in a frequency direction and a time direction and extracts a feature value per every predetermined time.

According to the present technology, the time frequency transform unit performs time frequency transform on the input time signal for each time frame and obtains the time frequency distribution. The likelihood distribution detecting unit obtains the tone likelihood distribution from the time frequency distribution. For example, the likelihood distribution detecting unit may include a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result. In addition, the feature value extracting unit smooths the likelihood distribution in the frequency direction and the time direction and extracts the feature value per the predetermined time.

As described above, according to the present technology, the tone likelihood distribution is obtained from the time frequency distribution of the input time signal, the feature value per every predetermined time is extracted from the likelihood distribution which has been smoothed in the frequency direction and the time direction, and it is possible to satisfactorily extract feature values of sound included in the input time signal.

According to the present technology, for example, the feature value extracting unit may further include a thinning unit which thins out the smoothed likelihood distribution in the frequency direction and/or the time direction. According to the present technology, for example, the feature value extracting unit may further include a quantizing unit which quantizes the smoothed likelihood distribution. In so doing, it is possible to reduce the data amount of the extracted feature values.

According to the present technology, for example, the apparatus may further include: a sound section detecting unit which detects a sound section based on the input time signal, and the likelihood distribution detecting unit may obtain tone likelihood distribution from the time frequency distribution within a range of the detected sound section. In so doing, it is possible to extract the feature values corresponding to the sound section.

In such a case, the sound section detecting unit may include a time frequency transform unit which performs time frequency transform on the input time signal for each time frame and obtains time frequency distribution, a feature value extracting unit which extracts feature value of amplitude, tone component intensity, and a spectrum approximate outline for each time frame based on the time frequency distribution, a scoring unit which obtains a score representing a sound section likeliness for each time frame based on the extracted feature values, a time smoothing unit which smooths the obtained score for each time frame in the time direction, and a threshold value determination unit which determinates a threshold value for the smoothed score for each time frame and obtains sound section information.

In addition, another embodiment of the present technology relates to a sound section detecting apparatus including: a time frequency transform unit which obtains time frequency distribution by performing time frequency transform on an input time signal for each time frame; a feature value extracting unit which extracts feature values of amplitude, tone component intensity, and a spectrum approximate outline for each time frame based on the time frequency distribution; and a scoring unit which obtains a score representing sound section likeliness for each time frame based on the extracted feature values.

According to the present technology, the time frequency transform unit performs time frequency transform on the input time signal for each time frame and obtains the time frequency distribution. The feature value extracting unit extracts the feature value of the amplitude, the tone component intensity, and the spectrum approximate outline for each time frame based on the time frequency distribution. In addition, the scoring unit obtains the score representing the sound section likeliness for each time frame based on the extracted feature values. According to the present technology, for example, the apparatus may further include: a time smoothing unit which smooths the obtained score for each time frame in the time direction; and a threshold value determination unit which determines a threshold for the smoothed score for each time frame and obtains sound section information.

As described above, according to the present technology, the feature values of the amplitude, the tone component intensity, and the spectrum approximate outline for each time frame are extracted from the time frequency distribution of the input time signal, a score representing sound section likeliness for each time frame is obtained from the feature values, and it is possible to precisely obtain the sound section information.

### Advantageous Effects of Invention

According to the present technology, it is possible to satisfactorily detect detection target sound such as running state sound or the like generated by a domestic electrical appliance.

### BRIEF DESCRIPTION OF DRAWINGS

FIG. 1 is a block diagram showing a configuration example of a sound detecting apparatus according to an embodiment.

FIG. 2 is a block diagram showing a configuration example of a feature value registration apparatus.

FIG. 3 is a diagram showing an example of a sound section and noise sections which are present before and after the sound section.

FIG. 4 is a block diagram showing a configuration example of a sound section detecting unit which configures the feature value registration apparatus.

FIG. 5A is a diagram illustrating a tone intensity feature value calculating unit.

FIG. 5B is a diagram illustrating the tone intensity feature value calculating unit.

FIG. 5C is a diagram illustrating the tone intensity feature value calculating unit.

FIG. 5D is a diagram illustrating the tone intensity feature value calculating unit.

FIG. 6 is a block diagram showing a configuration example of a tone likelihood distribution detecting unit which is included in the tone intensity feature value calculating unit for obtaining distribution of scores S(n, k) of tone characteristic likeliness.

FIG. 7A is a diagram schematically illustrating a characteristic that a quadratic polynomial function fits well in the vicinity of a spectrum peak of a tone characteristic while the quadratic polynomial function does not fit well in the vicinity of a spectrum peak of a noise characteristic.

FIG. 7B is a diagram schematically illustrating the characteristic that the quadratic polynomial function fits well in the vicinity of a spectrum peak of a tone characteristic while the quadratic polynomial function does not fit well in the vicinity of a spectrum peak of a noise characteristic.

FIG. 8A is a diagram schematically showing a variation in a peak of the tone characteristic in a time direction.

FIG. 8B is a diagram schematically showing fitting in a small region gamma on a spectrogram.

FIG. 9 is a flowchart showing an example of a processing procedure for detecting tone likelihood distribution by a tone likelihood distribution detecting unit.

FIG. 10 is a diagram showing an example of a tone component detecting result.

FIG. 11 is a diagram showing an example of a spectrogram of voice sound.

FIG. 12 is a block diagram showing a configuration example of a feature value extracting unit.

FIG. 13 is a block diagram showing a configuration example of a sound detecting unit.

FIG. 14 is a diagram illustrating operations of each part in the sound detecting unit.

FIG. 15 is a block diagram showing a configuration example of a compute apparatus which performs sound detection processing by software.

FIG. 16 is a flowchart showing an example of a procedure for detection target sound detecting processing by a CPU.

FIG. 17A is a diagram illustrating the recorded state of sound generated by an actual domestic electrical appliance.

FIG. 17B is a diagram illustrating the recorded state of sound generated by the actual domestic electrical appliance.

FIG. 17C is a diagram illustrating a recorded state of sound generated by the actual domestic electrical appliance.

### DESCRIPTION OF EMBODIMENT

Hereinafter, a description will be given of an embodiment for implementing the present technology (hereinafter, referred to as an “embodiment”). In addition, the description will be given in the following order.

1. Embodiment

2. Modified Example

### 1. EMBODIMENT

“Sound Detecting Apparatus”

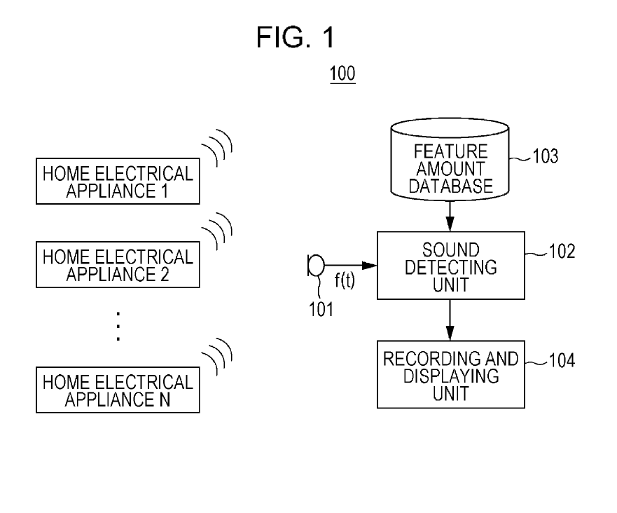

FIG. 1 shows a configuration example of a sound detecting apparatus 100 according to an embodiment. The sound detecting unit 100 includes a microphone 101, a sound detecting unit 102, a feature value database 103, and a recording and displaying unit 104.

The sound detecting apparatus 100 executes a sound detecting process for detecting running state sound (control sounds, notification sounds, operating sounds, alarm sounds, and the like) generated by a home electrical appliance and records and displays the detection result. That is, in the sound detecting process, a feature value per every predetermined time is extracted from a time signal f(t) obtained by collecting sound by the microphone 101, and the feature value is compared with a feature value sequence of a predetermined number of detection target sound items registered in the feature value database. Then, if a comparison result that the feature value substantially coincides with the feature value sequence of the predetermined detection target sound is obtained in the sound detecting process, the time and a name of the predetermined detection target sound are recorded and displayed.

The microphone 101 collects sounds in a room and outputs the time signal f(t). The sounds in the room also include running state sound (control sounds, notification sounds, operating sounds, alarm sounds, and the like) generated by the home electric appliances 1 to N. The sound detecting unit 102 obtains the time signal f(t), which is output from the microphone 101, as an input and extracts a feature value per every predetermined time from the time signal. In this regard, the sound detecting unit 102 configures the feature value extracting unit.

In the feature value data base 103 which configures a feature value maintaining unit, a feature value sequence including a predetermined number of detection target sound items is registered and maintained in association with a detection target sound name. In this embodiment, the predetermined number of detection target sound items means all or a part of the running state sound generated by the home electrical appliances 1 to N, for example. The sound detecting unit 102 compares an extracted feature value sequence with a feature value sequence of the predetermined number of detection target sound items maintained in the feature value database 103 every time a new feature value is extracted and obtains a detection result of a predetermined number of detection target sound. In this regard, the sound detecting unit 102 configures a comparison unit.

The recording and displaying unit 104 records the detection target sound detecting result by the sound detecting unit 102 in a recording medium along with the time and displays the detecting result on a display. For example, when the detection target sound detecting result by the sound detecting unit 102 indicate that notification sound A from the home electrical appliance 1 has been detected, the recording and displaying unit 104 records on the recording medium and displays on the display the fact that the notification sound A from the home electrical appliance 1 was produced and the time thereof.

Operations of the sound detecting apparatus 100 shown in FIG. 1 will be described. The microphone 101 collects sound in a room. The time signal output from the microphone 101 is supplied to the sound detecting unit 102. The sound detecting unit 102 extracts a feature value per every predetermined time from the time signal. Then, the sound detecting unit 102 compares the extracted feature value sequence with a feature value sequence of the predetermined number of detection target sound items maintained in the feature value database 103 every time a new feature value is extracted and obtains the detecting result of the predetermined number of detection target sound items. The detecting result is supplied to the recording and displaying unit 104. The recording and displaying unit 104 records on the recording medium and displays on the display the detecting result along with the time.

“Feature Value Registration Apparatus”

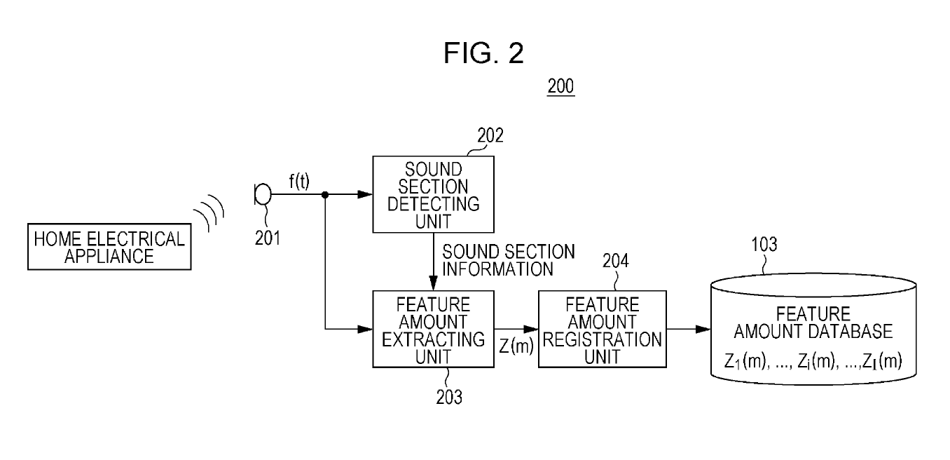

FIG. 2 shows a configuration example of a feature value registration apparatus 200 which registers a feature value sequence of detection target sound in the feature value database 103. The feature value registration apparatus 200 includes a microphone 201, a sound section detecting unit 202, a feature value extracting unit 203, and a feature value registration unit 204.

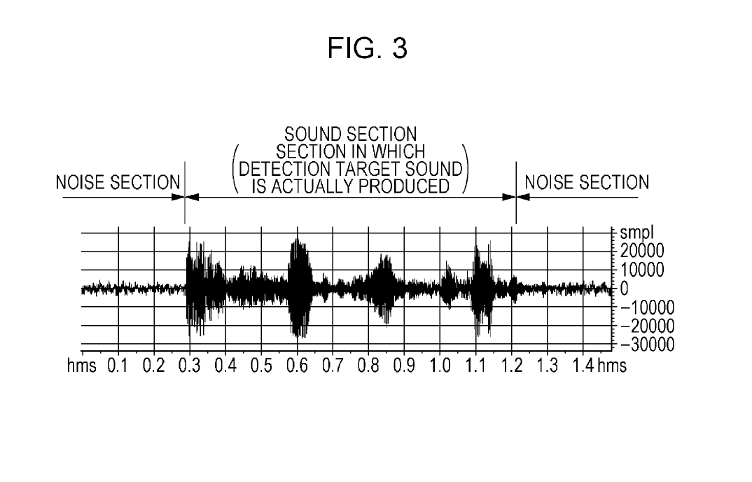

The feature value registration apparatus 200 executes a sound registration process (a sound section detecting process and a sound feature extracting process) and registers a feature value sequence of detection target sound (running state sound generated by a home electrical appliance) in a feature value database 103. Generally, noise sections are present before and after the detection target sound to be registered, which is recorded by the microphone 201. For this reason, a sound section including significant sound (detection target sound) to be actually registered is detected in the sound section detecting process. FIG. 3 shows an example of a sound section and noise sections which are present before and after the sound section. In the sound feature extracting process, a feature value which is useful for detecting the detection target sound is extracted from the time signal f(t) of the sound section which is obtained by the microphone 201 and registered in the feature value database 103 along with a detection target sound name.

The microphone 201 collects running state sound of a home electrical appliance, which is to be registered as detection target sound. The sound section detecting unit 202 obtains the time signal f(t), which is output from the microphone 201, as an input and detects a sound section, namely a section of the running state sound generated by the home electrical appliance from the time signal f(t). The feature value extracting unit 203 obtains the time signal f(t), which is output from the microphone 201, as an input and extracts a feature value per every predetermined time from the time signal f(t).

The feature value extracting unit 203 performs time frequency transform on the input time signal f(t) for every time frame, obtains time frequency distribution, obtains tone likelihood distribution from the time frequency distribution, smooths the likelihood distribution in a frequency direction and a time direction, and extracts a feature value per every predetermined time. In such a case, the feature value extracting unit 203 extracts the feature value in a range of a sound section based on sound section information supplied from the sound section detecting unit 202 and obtains a feature value sequence corresponding to a section of the operation condition sound generated by the home electrical appliance.

The feature value registration unit 204 associates and registers the feature value sequence corresponding to the running state sound generated by the home electrical appliance as a detection target sound, which has been obtained by the feature value extracting unit 203, with the detection target sound name (information on the running state sound) in the feature value database 103. In the example shown in the drawing, a state in which a feature value sequence including I detection target sound items Z1(m), Z2(m), . . . , Zi(m), . . . , ZI(m) are registered in the feature value database 103 is illustrated.

“Sound Section Detecting Unit”

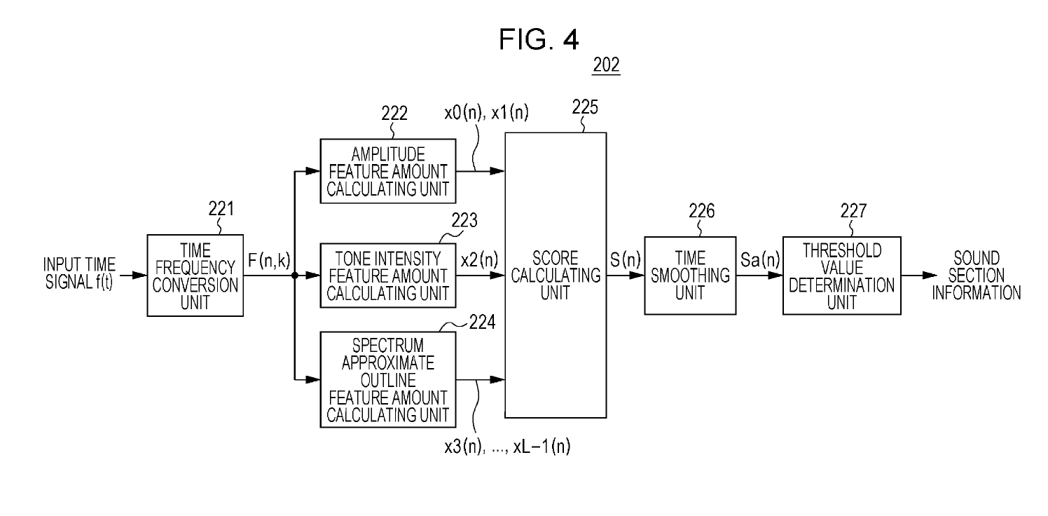

FIG. 4 shows a configuration example of the sound section detecting unit 202. An input to the sound section detecting unit 202 is the time signal f(t) which is obtained by the microphone 201 recording the detection target sound to be registered (the running state sound generated by the home electrical appliance), and noise sections are also included before and after the detection target signal as shown in FIG. 3. In addition, an output from the sound detecting unit 202 is sound section information indicating a sound section including significant sound to be actually registered (detection target sound).

The sound section detecting unit 202 includes a time frequency transform unit 221, an amplitude feature value calculating unit 222, a tone intensity feature value calculating unit 223, a spectrum approximate outline feature value calculating unit 224, a score calculating unit 225, a time smoothing unit 226, and a threshold value determination unit 227.

The time frequency transform unit 221 performs time frequency transform on the input time signal f(t) and obtains a time frequency signal F(n, k). Here, t represents discrete time, n represents a number of a time frame, and k represents a discrete frequency. The time frequency transform unit 221 performs time frequency transform on the input time signal f(t) by short-time Fourier transform and obtains the time frequency signal F(n, k) as shown in the following Equation (1).

$$\begin{matrix}[ Math . 1 ] & \\ F ( n , k ) = log \vert {\sum }_{t = 0}^{M - 1} W ( t ) f ( t - nR ) {e}^{j2π kn} \vert & ( 1 )\end{matrix}$$

Here, W(t) represents a window function, M represents a size of the window function, and R represents a frame time interval (=hop size). The time frequency signal F(n, k) represents a logarithmic amplitude value of a frequency component in a time frame n and at a frequency k and is a so-called spectrogram (time frequency distribution).

The amplitude feature value calculating unit 222 calculates an amplitude feature value x0(n) and x1(n) from the time frequency signal F(n, k). Specifically, the amplitude feature value calculating unit 222 obtains an average amplitude Aave(n) of a time section (with a length L before and after the target frame n) in the vicinity of a target frame n for a predetermined frequency range (with a lower limit KL and an upper limit KH), which is represented by the following Equation (2).

$$\begin{matrix}[ Math . 2 ] & \\ {A}_{ave} ( n ) = \frac{1}{2 L + 1} {\sum }_{n = - L}^{L} {\sum }_{k = {K}_{L}}^{{K}_{H}} exp ( F ( n , k ) ) & ( 2 )\end{matrix}$$

In addition, the amplitude feature value calculating unit 222 obtains an absolute amplitude Aabs(n) in the target frame n for the predetermined frequency range (with a lower limit KL and an upper limit KH), which is represented by the following Equation (3).

$$\begin{matrix}[ Math . 3 ] & \\ {A}_{abs} ( n ) = {\sum }_{k = {K}_{L}}^{{K}_{H}} exp ( F ( n , k ) ) & ( 3 )\end{matrix}$$

Furthermore, the amplitude feature value calculating unit 222 obtains a relative amplitude Arel(n) in the target frame n for the predetermined frequency range (with a lower limit KL and an upper limit KH), which is represented by the following Equation (4).

$$\begin{matrix}[ Math . 4 ] & \\ {A}_{rel} ( n ) = \frac{{A}_{abs} ( n )}{{A}_{ave} ( n )} & ( 4 )\end{matrix}$$

In addition, the amplitude feature value calculating unit 222 regards the absolute amplitude Aabs(n) as an amplitude feature value x0(n) and regards the relative amplitude Arel(n) as an amplitude feature value x1(n) as shown in the following Equation (5).

[Math. 5]

x₀(n)=A_{abs}(n), x₁(n)=Aᵣₑₗ(n) (5)

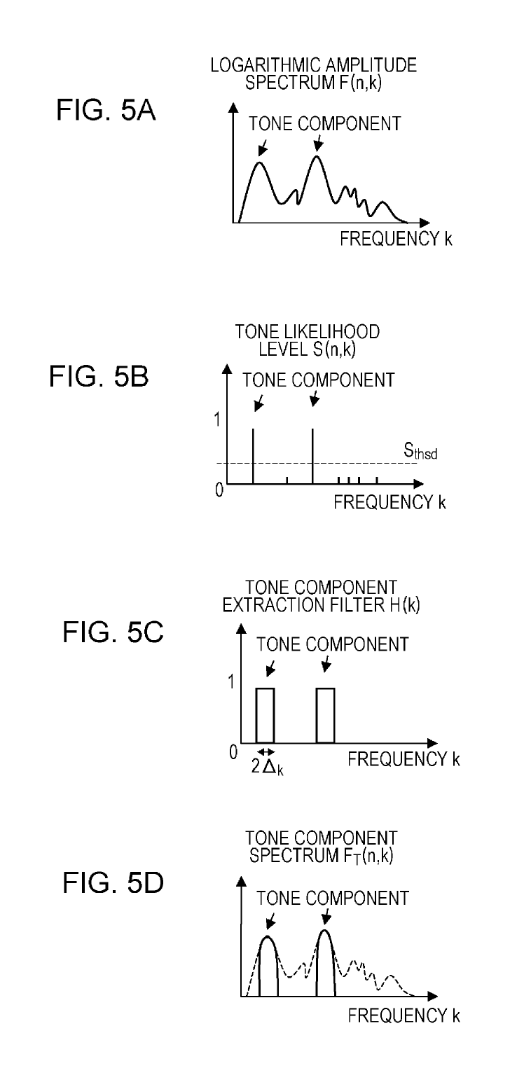

The tone intensity feature value calculating unit 223 calculates tone intensity feature value x2(n) from the time frequency signal F(n, k). The tone intensity feature value calculating unit 223 firstly transforms distribution of the time frequency signal F(n, k) (see FIG. 5A) into distribution of scores S(n, k) of tone characteristic likeliness (see FIG. 5B). Each score S(n, k) is a score from 0 to 1 which represents how much the time frequency component is “likely a tone component” in respective time n of F(n, k) at each frequency k. Specifically, the score S(n, k) is close to 1 at a position at which F(n, k) forms a peak of the tone characteristic in the frequency direction and is close to 0 at other positions.

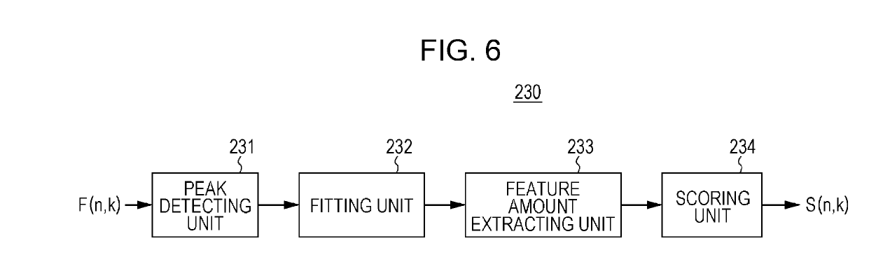

FIG. 6 shows a configuration example of the tone likelihood distribution detecting unit 230 which is included in the tone intensity feature value calculating unit 223 for obtaining the distribution of the scores S(n, k) of the tone characteristic likeliness. The tone likelihood distribution detecting unit 230 includes a peak detecting unit 231, a fitting unit 232, a feature value extracting unit 233, and a scoring unit 234.

The peak detecting unit 231 detects a peak in the frequency direction in each time frame of the spectrogram (distribution of the time frequency signal F(n, k)). That is, the peak detecting unit 231 detects whether or not a certain position corresponds to a peak (maximum value) in the frequency direction in all frames at all frequencies for the spectrogram.

The detection regarding whether or not the F(n, k) corresponds to a peak is performed by checking whether or not the following Equation (6) is satisfied, for example. Although a method using three points is exemplified as a peak detecting method, a method using five points is also applicable.

F(n, k−1)<F(n, k) and F(n, k)>F(n, k+1) (6)

The fitting unit 232 fits a tone model in a region in the vicinity of each peak, which has been detected by the peak detecting unit 231, as follows. First, the fitting unit 232 performs coordinate transform into coordinates including a target peak as an origin and sets a nearby time frequency region as shown by the following Equation (7). Here, delta N represents a nearby region (three points, for example) in the time direction, and delta k represents a nearby region (two points, for example) in the frequency direction.

[Math. 6]

Γ=[−Δ_{N}≦n≦Δ_{N}]×[−Δ_{K}≦k≦Δ_{K}] (7)

Next, the fitting unit 232 fits a tone model of a quadratic polynomial function as shown by the following Equation (8), for example, to the time frequency signal in the nearby region. In such a case, the fitting unit 232 performs the fitting based on square error minimum criterion between the time frequency distribution in the vicinity of the peak and the tone model, for example.

[Math. 7]

Y(k, n)=ak²+bk+ckn+dn²+en+g (8)

That is, the fitting unit 232 performs fitting by obtaining a coefficient which minimizes a square error, as shown in the following Equation (9), in the nearby region of the time frequency signal and the polynomial function as shown in the following Equation (10).

$$\begin{matrix}[ Math . 8 ] & \\ J ( a , b , c , d , e , g ) = {\sum }_{Γ} {( Y ( k , n ) - F ( k , n ) )}^{2} & ( 9 ) \\ ( \hat{a} , \hat{b} , \hat{c} , \hat{d} , \hat{e} , \hat{g} ) = arg min J ( a , b , c , d , e , g ) & ( 10 )\end{matrix}$$

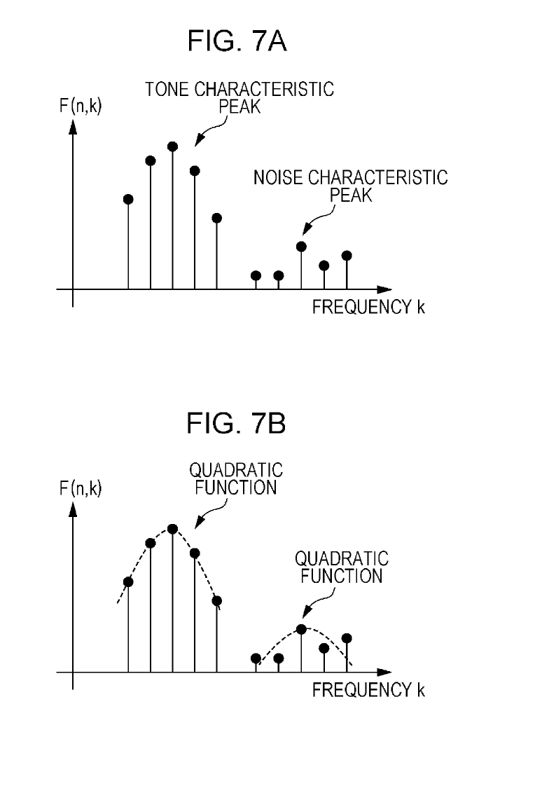

The quadratic polynomial function has a characteristic that the quadratic polynomial function fits well (the error is small) in the vicinity of the spectrum peak of the tone characteristic and does not fit well (the error is large) in the vicinity of a spectrum peak of the noise characteristic. FIGS. 7A and 7B are diagrams schematically showing the state. FIG. 7A schematically shows a spectrum near a peak of the tone characteristic in n-th frame, which is obtained by the aforementioned Equation (1).

FIG. 7B shows a state in which a quadratic function f0(k) shown by the following Equation (11) is applied to the spectrum in FIG. 7A. Here, a represents a peak curvature, k0 represents a frequency of an actual peak, and g0 represents a logarithmic amplitude value at a position of the actual peak. The quadratic function fits well around the spectrum peak of the tone characteristic component while the quadratic function tends to greatly deviate around the peak of the noise characteristic.

[Math. 9]

f₀(k)=a(k−k₀)²+g₀ (11)

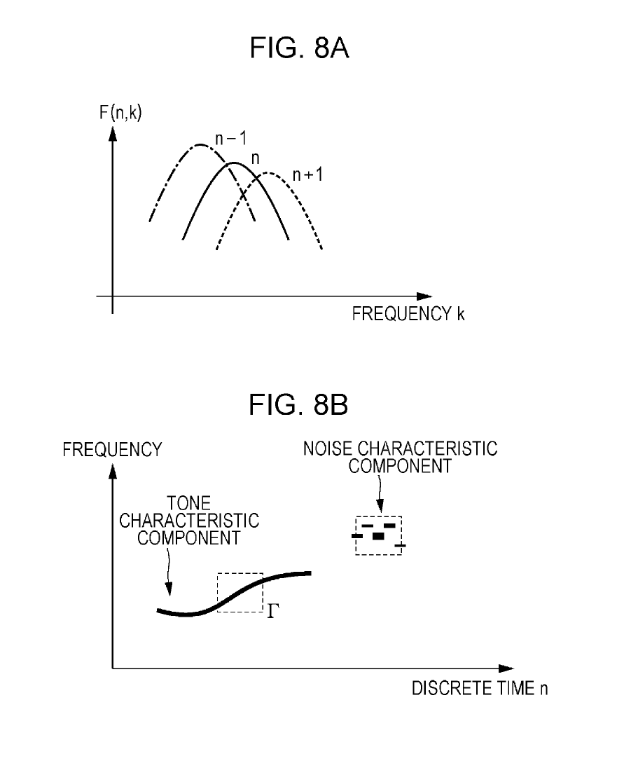

FIG. 8A schematically shows variation in the peak of the tone characteristic in the time direction. Amplitude and a frequency of the peak of the tone characteristic change in the previous and subsequent time frames while the approximate outline thereof is maintained. Although a spectrum which is actually obtained is a discrete point, the spectra are represented as a curve for convenience. One-dotted chain line shows a previous frame, a solid line shows a present frame, and a dotted line shows a next frame.

In many cases, the tone characteristic component is temporally continuous to some extent and can be represented as shift of quadratic functions with substantially the same shapes though a frequency and time slightly change. The variation Y(k, n) is represented by the following Equation (12). Since the spectrum is represented as logarithmic amplitude, a variation in the amplitude corresponds to displacement of the spectrum in the vertical direction. This is why an amplitude variation term f1(n) is added. Here, beta is a change rate of the frequency, and f1(n) is a time function which represents a variation in the amplitude at a peak position.

[Math. 10]

Y(k, n)=f₀(k−βn)+f₁(n) (12)

The variation Y(k, n) can be represented by the following Equation (13) if f1(n) is approximated by the quadratic function in the time direction. Since a, k0, beta, d1, e1, and g0 are constant, Equation (13) is equivalent to the aforementioned Equation (8) by appropriately transforming variables.

$$\begin{matrix}[ Math . 11 ] & \\ \begin{matrix}Y ( k , n ) = {a ( k - {k}_{0} - β n )}^{2} + {g}_{0} + {d}_{1} {n}^{2} + {e}_{1} n \\ = {ak}^{2} - 2 {ak}_{0} k - 2 {ak}_{0} kn + a {β}^{2} {n}^{2} + {d}_{1} {n}^{2} \\ + 2 {ak}_{0} β n + {e}_{1} n + {ak}_{0}^{2} + {g}_{0}\end{matrix} & ( 13 )\end{matrix}$$

FIG. 8B schematically shows fitting in the small region gamma on the spectrogram. Since similar shapes gradually change over time around the peak of the tone characteristic, Equation (8) tends to be well adapted. In relation to the vicinity of the peak of the noise characteristic, however, the shape and the frequency of the peak vary, and therefore, Equation (8) is not well adapted, that is, a large error occurs even if Equation (8) is optimally made to fit.

The aforementioned Equation (10) shows calculation for fitting in relation to all coefficients a, b, c, d, e, and g. However, fitting may be performed after some coefficients are fixed to constants in advance. In addition, fitting may be performed with two or more dimensional polynomial function.

Returning to FIG. 6, the feature value extracting unit 233 extracts feature values (x0, x1, x2, x3, x4, and x5) as shown by the following Equation (14) based on the fitting result (see the aforementioned Equation (10)) at each peak obtained by the fitting unit 232. Each feature value is a feature value representing a characteristic of a frequency component at each peak, and the feature value itself can be used for analyzing voice sound or music sound.

$$\begin{matrix}[ Math . 12 ] & \\ \begin{matrix}( Curvature of Peak ) {x}_{0} = \hat{a} \\ ( Frequency of Peak ) {x}_{1} = - \frac{b}{2 \hat{a}} \\ ( Logarithmic Amplitude Value of Peak ) {x}_{2} = \hat{g} \\ ( Change Rate of Frequency ) {x}_{3} = - \frac{\hat{c}}{2 \hat{a}} \\ ( Change Rate of Amplitude ) {x}_{4} = \hat{e} \\ ( Normalization Error in Fitting ) {x}_{5} = \frac{J ( \hat{a} , \hat{b} , \hat{c} , \hat{d} , \hat{e} , \hat{g} )}{{\sum }_{Γ} {( F ( n , k ) - \hat{g} )}^{2}}\end{matrix} \} & ( 14 )\end{matrix}$$

The scoring unit 234 obtains the score S(n, k) which represents the tone component likeliness of each peak by using the feature values extracted by the feature value extracting unit 233 for each peak, in order to quantize the tone component likeliness of each peak. The scoring unit 234 obtains the score S(n, k) as shown by the following Equation (15) by using one or a plurality of feature values from among the feature values (x0, x1, x2, x3, x4, and x5). In such a case, at least the normalization error x5 in fitting or the curvature of the peak in the frequency direction x0 is used.

$$\begin{matrix}[ Math . 13 ] & \\ S ( n , k ) = Sig m ( {\sum }_{i = 0}^{5} {w}_{i} {H}_{i} ( {x}_{i} ) + {w}_{6} ) & ( 15 )\end{matrix}$$

Here, Sigm(x) is a sigmoid function, wᵢ is a predetermined load coefficient, and Hᵢ(xᵢ) is a predetermined non-linear function for the i-th feature value xᵢ. It is possible to use a function as shown by the following Equation (16), for example, as the non-linear function Hᵢ(xᵢ). Here, uᵢ and vᵢ are predetermined load coefficients. Appropriate constant may be determined as wᵢ, uᵢ, and vᵢ in advance, which can be automatically selected by steepest descent learning using multiple data items, for example.

[Math. 14]

Hᵢ(xᵢ)=Sigm(uᵢxᵢ+vᵢ) (16)

The scoring unit 234 obtains the score S(n, k) which represents the tone component likeliness for each peak by Equation (15) as described above. In addition, the scoring unit 234 sets the score S(n, k) at a position (n, k) other than the peak to 0. The scoring unit 234 obtains the score S(n, k) of the tone component likeliness, which is a value from 0 to 1, at each time and at each frequency of the time frequency signal f(n, k).

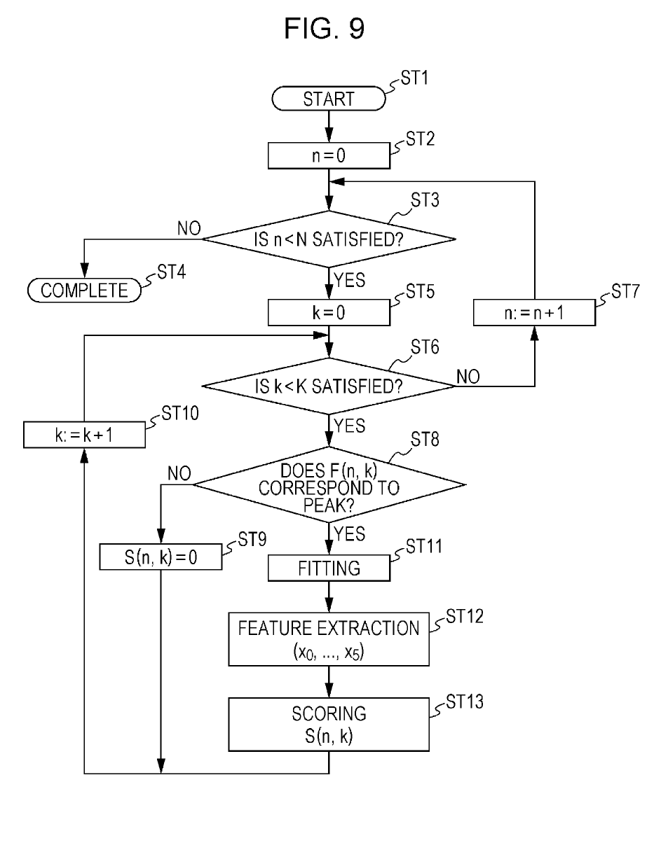

The flowchart in FIG. 9 shows an example of a processing procedure for tone likelihood distribution detection by the tone likelihood distribution detecting unit 230. The tone likelihood distribution detecting unit 230 starts the processing in Step ST1 and then moves on to the processing in Step ST2. In Step ST2, the tone likelihood distribution detecting unit 230 sets a number n of a frame (time frame) to 0.

Next, the tone likelihood distribution detecting unit 230 determines whether or not n<N is satisfied in Step ST3. In addition, the frames of the spectrogram (time frequency distribution) are present from 0 to N−1. If n<N is not satisfied, the tone likelihood distribution detecting unit 230 determines that the processing for all frames has been completed, and completes the processing in Step ST4.

If n<N is satisfied, the tone likelihood distribution detecting unit 230 sets a discrete frequency k to 0 in Step ST5. Then, the tone likelihood distribution detecting unit 230 determines whether or not k<K is satisfied in Step ST6. In addition, the discrete frequencies k of the spectrogram (time frequency distribution) are present from 0 to k−1. If k<K is not satisfied, the tone likelihood distribution detecting unit 230 determines that the processing for all discrete frequencies has been completed, increments n in Step ST7, then returns to Step ST3, and moves on to the processing on the next frame.

If k<K is satisfied in Step ST6, the tone likelihood distribution detecting unit 230 determines whether or not F(n, k) corresponds to the peak in Step ST8. If F(n, k) does not correspond to the peak, the tone likelihood distribution detecting unit 230 sets the score S(n, k) to 0 in Step ST9, increments k in Step ST10, then returns to Step ST6, and moves on to the processing on the next discrete frequency.

If F(n, k) corresponds to the peak in Step ST8, the tone likelihood distribution detecting unit 230 moves on to the processing in Step ST 11. In Step ST11, the tone likelihood distribution detecting unit 230 fits the tone model in a region in the vicinity of the peak. Then, the tone likelihood distribution detecting unit 230 extracts various feature values (x0, x1, x2, x3, x4, and x5) based on the fitting result in Step ST12.

Next, in Step ST13, the tone likelihood distribution detecting unit 230 obtains the score S(n, k), which is a value from 0 to 1 representing the tone component likeliness of the peak, by using the feature values extracted in Step ST12. The tone likelihood distribution detecting unit 230 increments k in Step ST10 after the processing in Step ST14, then returns to Step ST6, and moves on to the processing on the next discrete frequency.

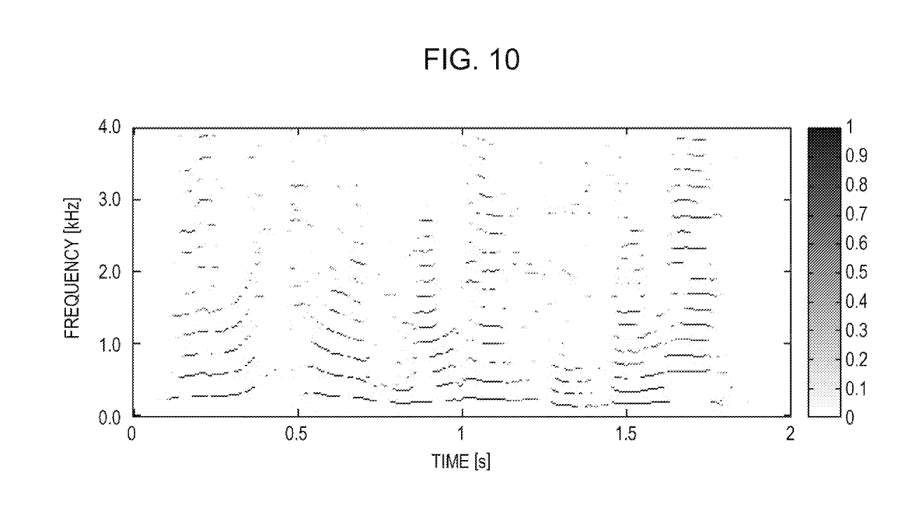

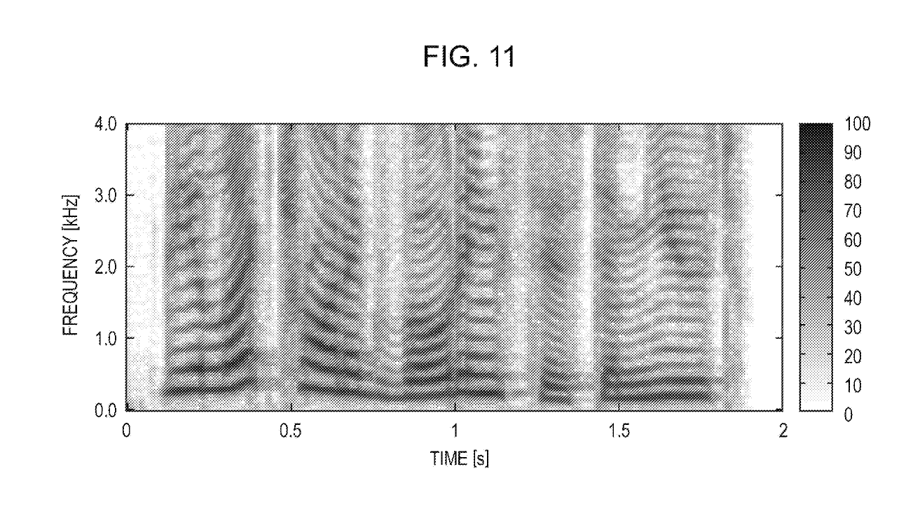

FIG. 10 shows an example of distribution of the scores S(n, k) of the tone component likeliness obtained by the tone likelihood distribution detecting unit 230, which is shown in FIG. 6, from the time frequency distribution (spectrogram) F(n, k) as shown in FIG. 11. A larger value of the score S(n, k) is shown by a darker black color, and it can be observed that the peaks of the noise characteristic are not substantially detected while the peaks of the tone characteristic component (the component forming black thick horizontal lines in FIG. 11) are substantially detected.

Returning to FIG. 4, the tone intensity feature value calculating unit 223 subsequently creates a tone component extracting filter H(n, k) (see FIG. 5C) which extracts only the component at a frequency position near a position at which the score S(n, k) is greater than a predetermined threshold value Sthsd (see FIG. 5B). The following Equation (17) represents the tone component extracting filter H(n, k).

$$\begin{matrix}[ Math . 15 ] & \\ H ( n , k ) = \{ \begin{matrix}1 & {k}_{T} - Δ k < k < {k}_{T} + Δ k \\ 0 & otherwise\end{matrix} & ( 17 )\end{matrix}$$

However, k_{T} represents a frequency at which the tone component is detected, and delta k represents a predetermined frequency width. Here, delta k is preferably 2/M when the size of the window function W(t) in the short-time Fourier transform (see Equation (1)) in order to obtain the time frequency signal F(n, k) as described above is M.

The tone intensity feature value calculating unit 223 subsequently multiples the original time frequency signal F(n, k) by the tone component extracting filter H(n, k) and obtains a spectrum (tone component spectrum) F_{T}(n, k) obtained by causing only the tone component to be left as shown in FIG. 5D. The following Equation (18) represents the tone component spectrum F_{T}(n, k).

[Math. 16]

F_{T}(n, k)=H(n, k)F(n, k) (18)

The tone intensity feature value calculating unit 223 finally sums up in a predetermined frequency region (with a lower limit K_{L} and an upper limit K_{H}) and obtains tone component intensity Atone(n) in the target frame n, which is represented by the following Equation (19).

$$\begin{matrix}[ Math . 17 ] & \\ {A}_{tone} ( n ) = {\sum }_{k = {K}_{L}}^{{K}_{H}} exp ( {F}_{T} ( n , k ) ) & ( 19 )\end{matrix}$$

Then, the tone intensity feature value calculating unit 223 regards the tone component intensity Atone(n) as the tone intensity feature value x2(n) as shown by the following Equation (20).

[Math. 18]

x₂(n)=Aₜₒₙₑ(n) (20)

The spectrum approximate outline feature value calculating unit 224 obtains the spectrum approximate outline feature values x3(n), x4(n), x5(n), and x6(n) as shown by the following Equation (21). Here, L represents a dimensional number of the feature value, and a case of L=7 is shown herein.

$$\begin{matrix}[ Math . 19 ] & \\ \begin{matrix}{x}_{3} ( n ) = {\sum }_{k = 0}^{N \text{/} 2 - 1} F ( k , n ) cos ( 2 π k \text{/} N ) \\ {x}_{4} ( n ) = {\sum }_{k = 0}^{N \text{/} 2 - 1} F ( k , n ) cos ( 4 π k \text{/} N ) \\ {x}_{5} ( n ) = {\sum }_{k = 0}^{N \text{/} 2 - 1} F ( k , n ) cos ( 6 π k \text{/} N ) \\ {x}_{6} ( n ) = {\sum }_{k = 0}^{N \text{/} 2 - 1} F ( k , n ) cos ( 8 π k \text{/} N )\end{matrix} \} & ( 21 )\end{matrix}$$

The spectrum approximate outline feature value is a low-dimensional cepstrum obtained by developing a logarithm spectrum by discrete cosine transform. The above description was given of four or less dimensional coefficients, higher dimensional coefficients may be also used. Moreover, coefficients which are obtained by distorting a frequency axis and performing discrete cosine transform thereon, such as so-called MFCC (Mel-Frequency Cepstral Coefficients) may be also used.

The aforementioned amplitude feature values x0(n) and x1(n), the tone intensity feature value x2(n), and the spectrum approximate outline feature values x3(n), x4(n), x5(n), and x6(n) configures L-dimensional (seven-dimensional in this case) feature value vector x(n) in the frame n. In addition, “volume of sound, a pitch of sound, and a tone of sound” are three sound factors, which are basic attributes indicating characteristics of the sound. Since the feature value vector x(n) is configured by amplitude (relating to volume of sound), tone component intensity (relating to a pitch of sound), and a spectrum approximate outline (relating to a tone of sound), the feature value vector x(n) configures a feature value relating to all the three sound factors.

The score calculating unit 225 synthesizes the factors of the feature value vector x(n) and represents whether or not the frame n is a sound section including significant sound to be actually registered (detection target sound) by a score S(n) from 0 to 1. This can be obtained by the following Equation (22), for example. Here, sigm( ) is a sigmoid function, uᵢ, vᵢ, and wᵢ (i=0, . . . , L−1) are constants which are selected from sample data based on experiences.

$$\begin{matrix}[ Math . 20 ] & \\ S ( n ) = Sig m ( {\sum }_{i = 0}^{L - 1} {w}_{i} {ξ}_{i} ( {x}_{i} ( n ) ) + {w}_{L} ) \\ {ξ}_{i} ( {x}_{i} ) = Sig m ( {u}_{i} {x}_{i} ( n ) + {v}_{i} ) & ( 22 )\end{matrix}$$

The time smoothing unit 226 smooths the score S(n), which has been obtained by the score calculating unit 225, in the time direction. In the smoothing processing, a moving average may be simply obtained, or a filter for obtaining a middle value such as a median filter may be used. The following Equation (23) shows an example in which the smoothed score Sa(n) is obtained by averaging processing. Here, delta n represents a size of the filter, which is a constant determined based on experiences.

$$\begin{matrix}[ Math . 21 ] & \\ S a ( n ) = \frac{1}{2 Δ n + 1} {\sum }_{τ = n - Δ n}^{n + Δ n} S ( n ) & ( 23 )\end{matrix}$$

The threshold value determination unit 227 compares the smoothed score Sa(n) in each frame n, which has been obtained by the time smoothing unit 226, with a threshold value, determines a frame section including a smoothed score Sa(n) which is equal to or greater than the threshold value as a sound section, and outputs sound section information indicating the frame section.

A description will be given of operations of the sound section detecting unit 202 shown in FIG. 4. The time signal f(t) which is obtained by collecting detection target sound to be registered (running state sound generated by a home electrical appliance) by a microphone 201 is supplied to the time frequency transform unit 221. The time frequency transform unit 221 performs time frequency transform on the input time signal f(t) and obtains the time frequency signal F(n, k). The time frequency signal F(n, k) is supplied to the amplitude feature value calculating unit 222, the tone intensity feature value calculating unit 223, and the spectrum approximate outline feature value calculating unit 224.

The amplitude feature value calculating unit 222 calculates the amplitude feature value x0(n) and x1(n) from the time frequency signal F(n, k) (see Equation (5)). In addition, the tone intensity feature value calculating unit 223 calculates the tone intensity feature value x2(n) from the time frequency signal F(n, k) (see Equation (20)). Furthermore, the spectrum approximate outline feature value calculating unit 224 calculates the spectrum approximate outline feature values x3(n), x4(n), x5(n), and x6(n) (see Equation (21)).

The amplitude feature values x0(n) and x1(n), the tone intensity feature value x2(n), and the spectrum approximate outline feature value x3(n), x4(n), x5(n), and x6) are supplied to the score calculating unit 225 as an L-dimensional (seven-dimensional in this case) feature value vector x(n) in the frame n. The score calculating unit 225 synthesizes the factors of the feature value vector x(n) and calculates a score S(n) from 0 to 1, which expresses whether or not the frame n is a sound section including significant sound to be actually registered (detection target sound) (see Equation (22)). The score S(n) is supplied to the time smoothing unit 226.

The time smoothing unit 226 smooths the score S(n) in the time direction (see Equation (23)), and the smoothed score Sa(n) is supplied to the threshold value determination unit 227. The threshold value determination unit 227 compares the smoothed score Sa(n) in each frame n with the threshold value, determines a frame section including a smoothed score Sa which is equal to or greater than the threshold value as a sound section, and outputs sound section information indicating the frame section.

The sound section detecting unit 202 shown in FIG. 4 extracts the feature values of amplitude, tone component intensity, and a spectrum approximate outline in each time frame from the time frequency distribution F(n, k) of the input time signal f(t) and obtains a score S(n) representing sound section likeliness of each time frame from the feature values. For this reason, it is possible to precisely obtain the sound section information which indicates the section of the detected sound even if the detected sound to be registered is recorded under a noise environment.

“Feature Value Extracting Unit”

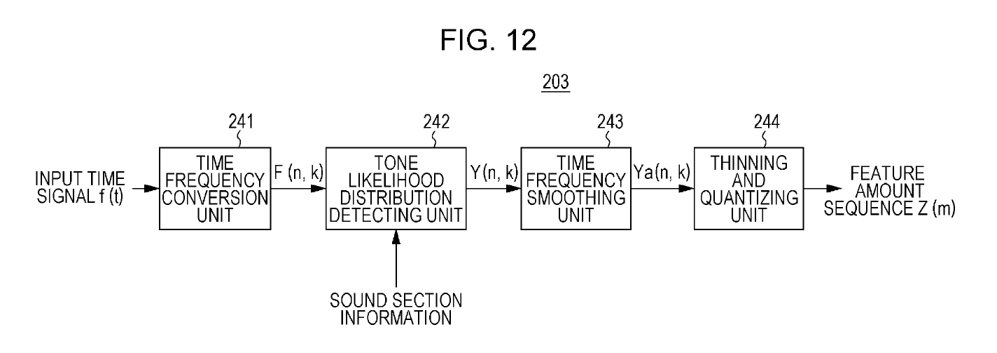

FIG. 12 shows a configuration example of the feature value extracting unit 203. The feature value extracting unit 203 obtains as an input the time signal f(t) obtained by recording the detection target sound to be registered(the running state sound generated by the home electrical appliance) by a microphone 201 and, the time signal f(t) also includes noise sections before and after the detection target sound as shown in FIG. 3. In addition, the feature value extracting unit 203 outputs a feature value sequence extracted per every predetermined time in the section of the detection target sound to be registered.

The feature value extracting unit 203 includes a time frequency transform unit 241, a tone likelihood distribution detecting unit 242, a time frequency smoothing unit 243, and a thinning and quantizing unit 244. The time frequency transform unit 241 performs time frequency transform on the input time signal f(t) and obtains the time frequency signal F(n, k) in the same manner as the aforementioned time frequency transform unit 221 of the sound section detecting unit 202. In addition, the feature value extracting unit 203 may use the time frequency signal F(n, k) obtained by the time frequency transform unit 221 of the sound section detecting unit 202, and in such a case, it is not necessary to provide the time frequency transform unit 241.

The tone likelihood distribution detecting unit 242 detects tone likelihood distribution in the sound section based on the sound section information from the sound section detecting unit 202. That is, the tone likelihood distribution detecting unit 242 firstly transforms the distribution of the time frequency signals F(n, k) (see FIG. 5A) into distribution of scores S(n, k) of tone characteristic likeliness (see FIG. 5B) in the same manner as the aforementioned tone intensity feature value calculating unit 223 of the sound section detecting unit 202.

The tone likelihood distribution detecting unit 242 subsequently obtains tone likelihood distribution Y(n, k) in the sound section including significant sound to be registered (detection target sound) as shown by the following Equation (24) by using the sound section information.

$$\begin{matrix}[ Math . 22 ] & \\ Y ( n , k ) = \{ \begin{matrix}S ( n , k ) & When n is inside sound section \\ 0 & When n is outside sound section\end{matrix} & ( 24 )\end{matrix}$$

The time frequency smoothing unit 243 smooths the tone likelihood distribution Y(n, k) in the sound section, which has been obtained by the tone likelihood distribution detecting unit 242, in the time direction and the frequency direction and obtains smoothed tone likelihood distribution Ya(n, k) as shown by the following Equation (25).

$$\begin{matrix}[ Math . 23 ] & \\ Y a ( n , k ) = {\sum }_{τ = - {Δ}_{n}}^{{Δ}_{n}} {\sum }_{λ = - {Δ}_{k}}^{{Δ}_{k}} Y ( n - τ , k - λ ) H ( τ , λ ) & ( 25 )\end{matrix}$$

Here, delta k represents a size of the smoothing filter on one side in the frequency direction, delta n represents a size thereof on one side in the time direction, and H(n, k) represents a quadratic impulse response of the smoothing filter. In addition, the above description was given of a case of a filter with no distortion in the frequency direction for simplification. However, the smoothing may be performed using a filter distorting a frequency axis, such as the Mel frequency.

The thinning and quantizing unit 344 thins out the smoothed tone likelihood distribution Ya(n, k) obtained by the time frequency smoothing unit 243, further quantizes the tone likelihood distribution Ya(n, k), and create feature values Z(m, l) of the significant sound to be registered (detection target sound) as shown by the following Equation (26).

[Math. 24]

z(m, l)=Quant[Ya(mT, lK)] (0≦m≦M−1, 0≦l≦L−1) (26)

Here, T represents a discretization step in the time direction, K represents a discretization step in the frequency direction, m represents thinned discrete time, and l represents a thinned discrete frequency. In addition, M represents a number of frames in the time direction (corresponding to time length of the significant sound to be registered (detection target sound)), L represents a number of dimensions in the frequency direction, and Quant[ ] represents a function of quantization.

The aforementioned feature values z(m, l) can be represented as Z(m) by collective vector notation in the frequency direction as shown by the following Equation (27).

[Math. 25]

Z(m)=[z(m,0), . . . , z(m, L−1)] (0≦m≦M−1) (27)

In such a case, the aforementioned feature values Z(m, l) are configured by M vectors Z(0), . . . , Z(M−1), Z(M) which have been extracted per T in the time direction. Therefore, the thinning and quantizing unit 244 can obtains a sequence Z(m) of the feature values (vectors) extracted per every predetermined time in the section including the detecting target sound to be registered.

In addition, it can be also considered that the smoothed tone likelihood distribution Ya(n, k) which has been obtained by the time frequency smoothing unit 243 is used as it is as an output from the feature value extracting unit 203, namely a feature value sequence. However, since the tone likelihood distribution Ya(n, k) has been smoothed, it is not necessary to prepare all time and frequency data. It is possible to reduce an amount of information by thinning out in the time direction and the frequency direction. In addition, it is possible to transform data of 8 bits or 16 bits into data of 2 bits or 3 bits by quantization. Since thinning and quantization are performed as described above, it is possible to reduce the amount of information on the feature value (vector) sequence Z(m) and to thereby reduce processing burden for matching calculation by the sound detecting apparatus 100 which will be described later.

A description will be given of operations of the feature value extracting unit 203 shown in FIG. 12. The time signal f(t) obtained by collecting the detection target sound (the running state sound generated by the home electrical appliance) to be registered by the microphone 201 is supplied to the time frequency transform unit 241. The time frequency transform unit 241 performs time frequency conversion on the input time signal f(t) and obtains the time frequency signal F(n, k). The time frequency signal F(n, k) is supplied to the tone likelihood distribution detecting unit 242. In addition, the sound section information obtained by the sound section detecting unit 202 is also supplied to the tone likelihood distribution detecting unit 242.

The tone likelihood distribution detecting unit 242 transforms distribution of the time frequency signals F(n, k) into distribution of scores S(n, k) of the tone characteristic likeliness, and further obtains the tone likelihood distribution Y(n, k) in the sound section including the significant sound to be registered (detection target sound) by using the sound section information (see Equation (24)). The tone likelihood distribution Y(n, k) is supplied to the time frequency smoothing unit 243.

The time frequency smoothing unit 243 smooths the tone likelihood distribution Y(n, k) in the time direction and the frequency direction and obtains the smoothed tone likelihood distribution Ya(n, k) (see Equation (25)). The tone likelihood distribution Ya(n, k) is supplied to the thinning and quantizing unit 244. The thinning and quantizing unit 244 thins out the tone likelihood distribution Ya(n, k), further quantize the thinned tone likelihood distribution Ya(n, k), and obtains a feature values z(m, l) of the significant sound to be registered (detection target sound), namely the feature value sequence Z(m) (see Equations (26) and (27)).

Returning to FIG. 2, the feature value registration unit 204 associates and registers the feature value sequence Z(m) of the detection target sound to be registered, which has been created by the feature value registration unit 204, with a detection target sound name (information on the operation condition sound) in the feature value database 103.

A description will be given of operations of the feature value registration apparatus 200 shown in FIG. 2. The microphone 201 collects running state sound of a home electrical appliance to be registered as detection target sound. The time signal f(t) output from the microphone 201 is supplied to the sound section detecting unit 202 and the feature value extracting unit 203. The sound section detecting unit 202 detects the sound section, namely the section including the running state sound generated by the home electrical appliance, from the input time signal f(t) and outputs the sound section information. The sound section information is supplied to the feature value extracting unit 203.

The feature value extracting unit 203 performs time frequency conversion on the input time signal f(t) for each time frame, obtains the distribution of the time frequency signals F(n, k), and further obtains tone likelihood distribution, namely distribution of the scores S(n, k) from the time frequency distribution. Then, the feature value extracting unit 203 obtains the tone likelihood distribution Y(n, k) of the sound section from the distribution of the scores S(n, k) based on the sound section information, smooths the tone likelihood distribution Y(n, k) in the time direction and the frequency direction, and further performs thinning and quantizing processing thereon to create the feature value sequence Z(m).

The feature value sequence Z(m) of the detection target sound to be registered (the running state sound of the home electrical appliance), which has been created by the feature value extracting unit 203, is supplied to the feature value registration unit 204. The feature value registration unit 204 associates and registers the feature value sequence Z(m) with the detection target sound name (information on the running state sound) in the feature value database 103. In the following description, it is assumed that I detection target sound items are registered, the feature value sequences thereof will be represented as Z1(m), Z2(m), . . . , Zi(m), . . . , ZI(m), and the numbers of time frames in the feature value sequences (the number of vectors aligned in the time direction) will be represented as M1, M2, . . . , Mi, . . . , MI.

“Sound Detecting Unit”

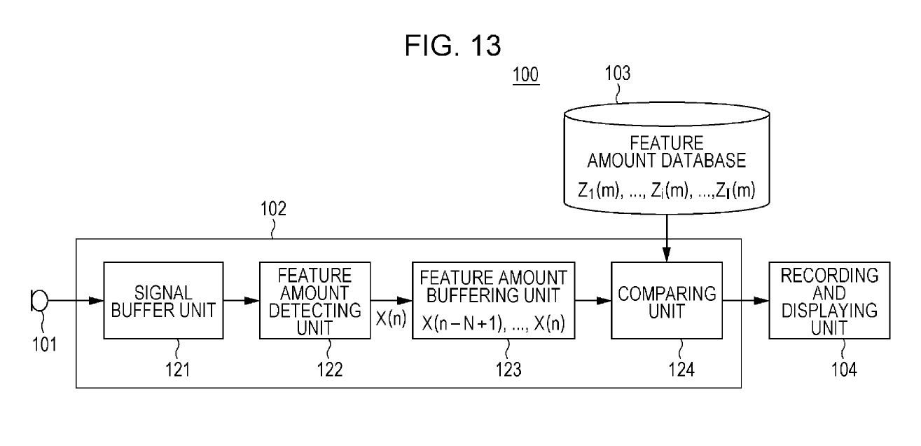

FIG. 13 shows a configuration example of the sound detecting unit 102. The sound detecting unit 102 includes a signal buffering unit 121, a feature value extracting unit 122, a feature value buffering unit 123, and a comparison unit 124. The signal buffering unit 121 buffers a predetermined number of signal samples of the time signal f(t) which is obtained by collecting sound by the microphone 101. The predetermined number means a number of samples with which the feature value extracting unit 122 can newly calculate a feature value sequence corresponding to one frame.

The feature value extracting unit 122 extracts feature values per every predetermined time based on the signal samples of the time signal f(t), which has been buffered by the signal buffering unit 121. Although not described in detail, the feature value extracting unit 203 is configured in the same manner as the aforementioned feature value extracting unit 203 (see FIG. 12) of the feature value registration apparatus 200.

However, the tone likelihood detecting unit 242 in the feature value extracting unit 122 obtains the tone likelihood distribution Y(n, k) in all sections. That is, the tone likelihood distribution detecting unit 242 outputs the distribution of the scores S(n, k), which has been obtained from the distribution of the time frequency signals F(n, k), as it is. Then, the thinning and quantizing unit 244 outputs a newly extracted feature value (vector) X(n) per T (discretization step in the time direction) for all sections of the input time signal f(t). Here, n represents a number of a frame of the feature value which is being currently extracted (corresponding to current discrete time).

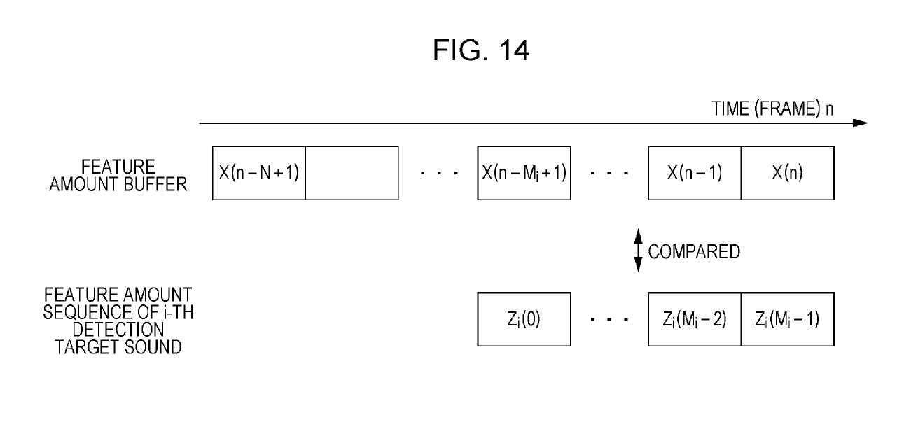

The feature value buffering unit 123 saves the newest N feature values (vectors) X(n) output from the feature value extracting unit 122 as shown in FIG. 14. Here, N is at least a number which is equal to or greater than a number of frames (the number of vectors aligned in the time direction) of the longest feature value sequences from among the feature value sequences Z1(m), Z2(m), . . . , Zi(m), . . . , ZI(m) registered (maintained) in the feature value database 103.

The comparison unit 124 sequentially compares the feature value sequences saved in the signal buffering unit 123 with feature value sequences of I detection target sound items registered in the feature value database 103 every time the feature value extracting unit 122 extracts the new feature value X(n), and obtains detection results of the I detection target sound items. Here, if i represents the number of the detection target sound number, the length of each detection target sound item (frame number Mi) differs from each other.

As shown in FIG. 14, the comparison unit 124 combines the latest frame n in the feature value buffering unit 123 with the last frame Zi(Mi−1) of the feature value sequence of the detection target sound and calculates similarity by using a frame with a length of the feature value sequence of the detection target sound from among the N feature values saved in the feature value buffering unit 123. The similarity Sim(n, i) can be calculated by correlation between feature values as shown by the following Equation (28), for example. Here, Sim(n, i) means similarity with a feature value sequence of i-th detection target sound in the n-th frame. The comparison unit 124 determines that “the i-th detection target sound is generated at time n” and outputs the determination result when the similarity is greater than a predetermined threshold value.

$$\begin{matrix}[ Math . 26 ] & \\ Sim ( n , i ) = \frac{{\sum }_{m = 0}^{{M}_{i} - 1} X ( n - {M}_{i} - 1 + m ) {Z}_{i} ( m )}{\sqrt{{\sum }_{m = 0}^{{M}_{1} - 1} {X}^{2} ( n - {M}_{i} - 1 + m ) {\sum }_{m = 0}^{{M}_{i} - 1} {Z}_{i}^{2} ( m )}} & ( 28 )\end{matrix}$$

A description will be given of operations of the sound detecting unit 102 shown in FIG. 13. The time signal f(t) obtained by collecting sound by the microphone 101 is supplied to the signal buffering unit 121, and the predetermined number of signal samples are buffered. The feature value extracting unit 122 extracts a feature value per very predetermined time based on the signal samples of the time signal f(t) buffered by the signal buffering unit 121. Then, the feature value extracting unit 122 sequentially outputs a newly extracted feature value (vector) X(n) per T (the discretization step in the time direction).

The feature value X(n) which has been extracted by the feature value extracting unit 122 is supplied to the feature value buffering unit 123, and the latest N feature values X(n) are saved therein. The comparison unit 124 sequentially compares the feature value sequence saved in the signal buffering unit 123 with a feature value sequence of the I detection target sound items, which are registered in the feature value database 103, every time the new feature value X(n) is extracted by the feature value extracting unit 122, and obtains the detection result of the I detection target sound items.

In such a case, the comparison unit 124 combines the latest frame n in the feature value buffering unit 123 with the last frame Zi(Mi−1) of the feature value sequence of the detection target sound and calculates similarity by using a frame with a length of the feature value sequence of the detection target sound (see FIG. 14). Then, the comparison unit 124 determines that “the i-th detection target sound is generated at time n” and outputs the determination result when the similarity is greater than the predetermined threshold value.

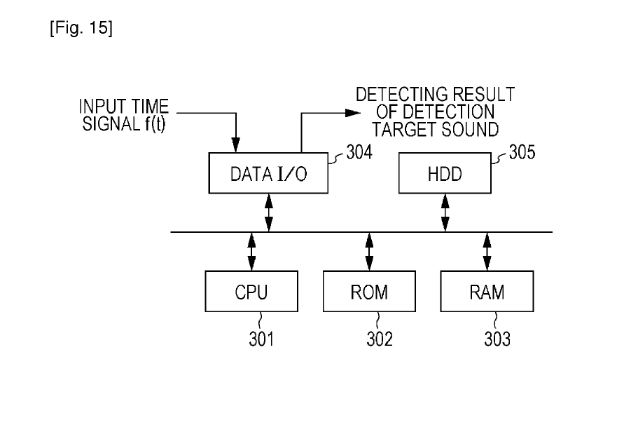

In addition, the sound detecting apparatus 100 shown in FIG. 1 can be configured as hardware or software. For example, it is possible to cause the computer apparatus 300 shown in FIG. 15 to include a part of or all the functions of the sound detecting apparatus 100 shown in FIG. 1 and performs the same processing of detecting detection target sound as that described above.

The computer apparatus 300 includes a CPU (Central Processing Unit) 301, a ROM (Read Only Memory) 302, a RAM (Random Access Memory) 303, a data input and output unit (data I/O) 304, and an HDD (Hard Disk Drive) 305. The ROM 302 stores a processing program and the like of the CPU 301. The RAM 303 functions as a work area of the CPU 301. The CPU 301 reads the processing program stored on the ROM 302 as necessary, transfers to and develops in the RAM 303 the read processing program, reads the developed processing program, and executes tone component detecting processing.

The input time signal f(t) is input to the computer apparatus 300 via the data I/O 304 and accumulated in the HDD 305. The CPU 301 performs the processing of detecting detection target sound on the input time signal f(t) accumulated in the HDD 305 as described above. Then, the detection result is output to the outside via the data I/O 304. In addition, a feature value sequence of I detection target sound items are registered and maintained in the HDD 305 in advance.

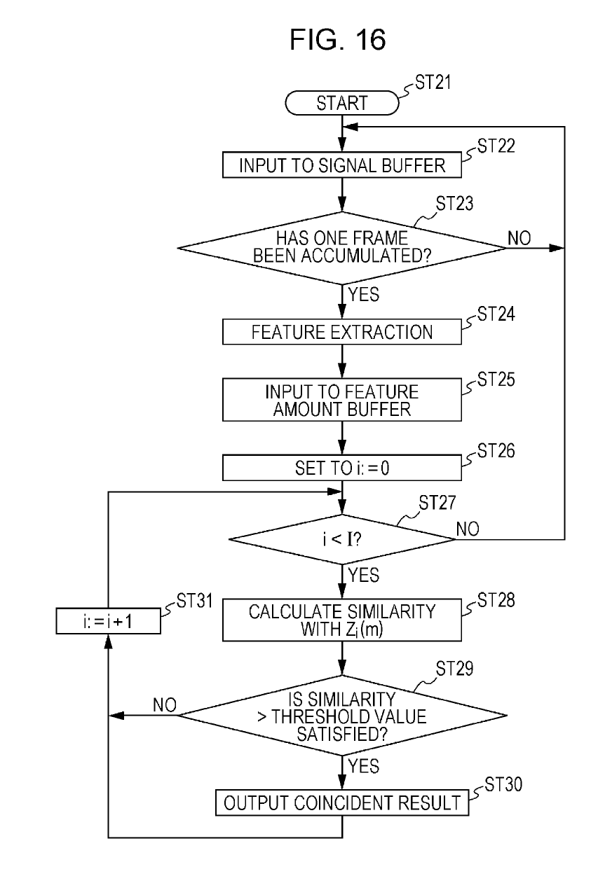

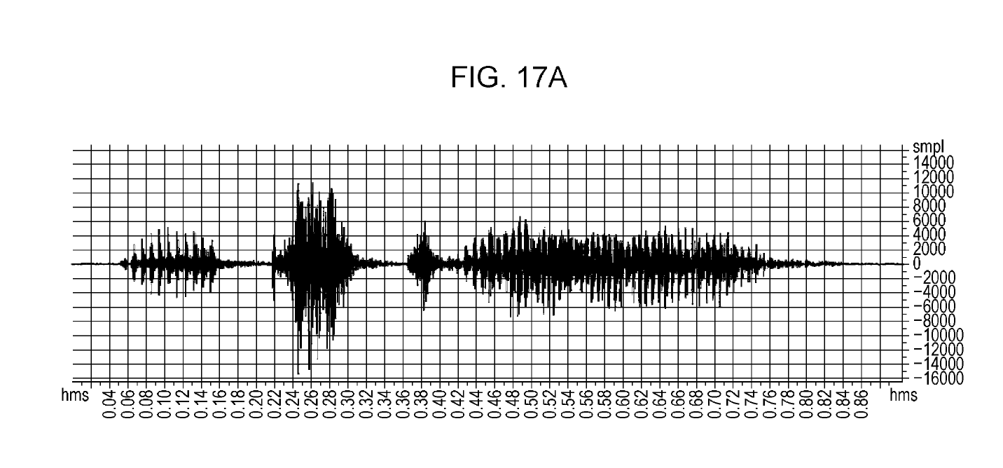

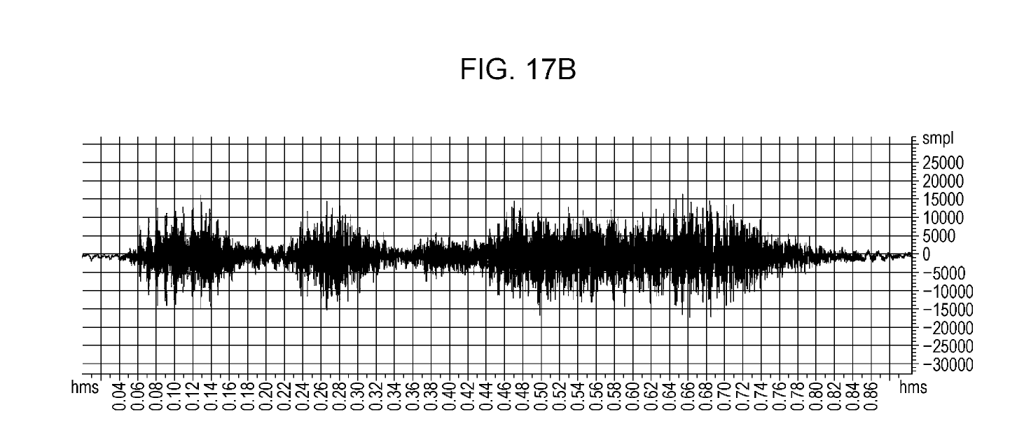

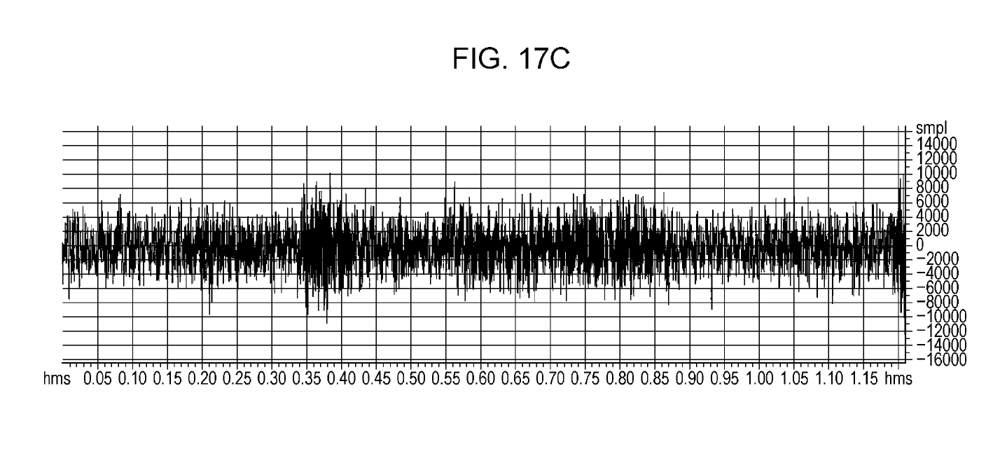

The flowchart in FIG. 16 shows an example of a processing procedure for detecting the detection target sound by the CPU 301. In Step ST21, the CPU 301 starts the processing and then moves on to the processing in Step ST22. In Step ST22, the CPU 301 inputs the input time signal f(t) to the signal buffering unit configured in the HDD 305, for example. Then, the CPU 301 determines whether or not a number of samples with which the feature value sequence corresponding to one frame can be calculated have been accumulated, in Step ST23.

If the number of samples corresponding to one frame have been accumulated, the CPU 301 performs processing of extracting the feature value X(n) in Step ST24. The CPU 301 inputs the extracted feature value X(n) to the feature value buffering unit configured in the HDD 305, for example, in Step ST25. Then, the CPU 301 sets the number i of the detection target sound to zero in Step ST26.

Next, the CPU 301 determines whether or not i<I is satisfied in Step ST27. If i<I is satisfied, the CPU 301 calculates similarity between the feature value sequence saved in the signal buffering unit and the feature value sequence Zi(m) of the i-th detection target sound registered in the HDD 305 in Step ST28. Then, the CPU 301 determines whether or not the similarity>the threshold value is satisfied in Step ST29.

If the similarity>the threshold value is satisfied, the CPU 301 outputs a result indicating coincidence in Step ST30. That is, a determination result that “the i-th detection target sound is generated at time n” is output as a detection output. Thereafter, the CPU 301 increments i in Step ST31 and returns to the processing in Step ST27. In addition, if the similarity>the threshold value is not satisfied in Step ST29. The CPU 301 immediately increments i in Step ST31 and returns to the processing in Step ST27. If i>I is not satisfied in Step ST27, the CPU 301 determines that the processing on the current frame has been completed, returns to the processing in Step ST22, and moves on to the processing on the next frame.

Next, the CPU 301 sets the number n of the frame (time frame) to 0 in Step ST3. Then, the CPU 301 determines whether or not n<N is satisfied in Step ST4. In addition, it is assumed that the frames of the spectrogram (time frequency distribution) are present from 0 to N−1. If n<N is not satisfied, the CPU 301 determines that the processing of all the frames has been completed and then completes the processing in Step ST5.

If n<N is satisfied, the CPU 301 sets the discrete frequency k to 0 in Step ST6. Then, the CPU 301 determines whether or not k<K is satisfied in Step ST7. In addition, it is assumed that the discrete frequencies k of the spectrogram (time frequency distribution) are present from 0 to k−1. If k<K is not satisfied, the CPU 301 determines that the processing on all the discrete frequencies has been completed, increments n in Step ST8, then returns to Step ST4, and moves on to the processing on the next frame.

If k<K is satisfied in Step ST7, the CPU 301 determines whether or not F(n, k) corresponds to a peak in Step ST9. If F(n, k) does not correspond to the peak, the CPU 301 sets the score S(n, k) to 0 in Step ST10, increments k in Step ST11, then returns to Step ST7, and moves on the processing on the next discrete frequency.

If F(n, k) corresponds to the peak in Step ST9, the CPU 301 moves on to the processing in Step ST12. In Step ST12, the CPU 301 fits the tone model in the region in the vicinity of the peak. Then, the CPU 301 extracts various feature values (x0, x1, x2, x3, x4, and x5) based on the fitting result in Step ST13.

Next, in Step ST14, the CPU 301 obtains a score S(n, k), which represents a tone component likelihood of the peak with a value from 0 to 1, by using the feature values extracted in Step ST13. The CPU 301 increments k in Step ST11 after the processing in Step ST14, then returns to Step ST7, and moves on to the processing on the next discrete frequency.

As described above, the sound detecting apparatus 100 shown in FIG. 1 obtains the tone likelihood distribution from the time frequency distribution of the input time signal f(t) obtained by collecting sound by the microphone 101 and extracts and uses the feature value per every predetermined time from the likelihood distribution which has been smoothed in the frequency direction and the time direction. Accordingly, it is possible to precisely detect the detection target sound (running state sound and the like generated from a home electrical appliance) without depending on an installation position of the microphone 101.

In addition, the sound detecting apparatus 100 shown in FIG. 1 records on a recording medium and displays on a display the detection result of the detection target sound, which has been obtained by the sound detecting unit 102, along with time. Accordingly, it is possible to automatically record running states of home electrical appliances and the like at home and obtains a self action history (so-called life log). In addition, it is possible to automatically visualize sound notification for people with hearing difficulties.

### 2. MODIFIED EXAMPLE

The above embodiment shows an example in which running state sound generated from a home electrical appliance (control sounds, notification sounds, operating sounds, alarm sounds, and the like) at home is detected. However, the present technology can be applied to use in automating detection relating to sound functions of a product fabricated in a production plant as well as domestic use. In addition, it is a matter of fact that the present technology can be applied not only to detection of running state sound but also to detection of voice sound of a specific person or a specific animal or other environmental sound.

Although the above description was given of the embodiment in which the time frequency transform was performed based on the short-time Fourier transform, it can be also considered that the input time signal is subjected to the time frequency transform by using another transform method such as wavelet transform. In addition, although the above description was given of the embodiment in which the fitting was performed based on the square error minimum criterion between the time frequency distribution in the vicinity of each detected peak and the tone model, it can be also considered that the fitting is performed based on a quadruplicate error minimum criterion, a minimum entropy criterion, or the like.

In addition, the present technology can be configured as follows.

(1) A sound detecting apparatus including: a feature value extracting unit which extracts a feature value per every predetermined time from an input time signal; a feature value maintaining unit which maintains a feature value sequence of a predetermined number of detection target sound items; and a comparison unit which respectively compares a feature value sequence extracted by the feature value extracting unit with a feature value sequence of the maintained predetermined number of detecting target sound items and obtains detection results of the predetermined number of detection target sound items every time the feature value extracting unit newly extracts a feature value, wherein the feature value extracting unit includes a time frequency transform unit which performs time frequency transform on the input time signal for each time frame and obtains time frequency distribution and a likelihood distribution detecting unit which obtains tone likelihood distribution from the time frequency distribution, smooths the obtained likelihood distribution in a frequency direction and a time direction, and extracts the feature value per the predetermined time.

(2) The apparatus according to (1), wherein the likelihood distribution detecting unit includes a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result.

(3) The apparatus according to (1) or (2), wherein the feature value extracting unit further includes a thinning unit which thins out the smoothed likelihood distribution in the frequency direction and/or the time direction.

(4) The apparatus according to (1) or (2), wherein the feature value extracting unit further includes a quantizing unit which quantizes the smoothed likelihood distribution.

(5) The apparatus according to any one of (1) to (4), wherein the comparison unit obtains similarity based on correlation between corresponding feature values between the feature value sequence of the maintained detection target sound items and the feature value sequence extracted by the feature value extracting unit for each of the predetermined number of detection target sound items and obtains the detection results of the detection target sound items based on the obtained similarity.

(6) The apparatus according to any one of (1) to (5), further including:

a recording control unit which records the detection results of the predetermined number of detection target sound items along with time information on a recording medium.

(7) A sound detecting method including: extracting a feature value per every predetermined time from an input time signal; and respectively comparing a feature value sequence extracted by the feature value extracting unit with a feature value sequence of the maintained predetermined number of detecting target sound items and obtaining detection results of the predetermined number of detection target sound items every time the feature value is newly extracted in the extracting of the feature value, wherein in the extracting of the feature value, time frequency transform is performed on the input time signal for each time frame, time frequency distribution is obtained, tone likelihood distribution is obtained from the time frequency distribution, the likelihood distribution is smoothed in a frequency direction and a time direction, and the feature value per the predetermined time is extracted.

(8) A program which causes a computer to perform: extracting a feature value per every predetermined time from an input time signal; and respectively comparing a feature value sequence extracted by the feature value extracting unit with a feature value sequence of the maintained predetermined number of detecting target sound items and obtaining detection results of the predetermined number of detection target sound items every time the feature value is newly extracted in the extracting of the feature value, wherein in the extracting of the feature value, time frequency transform is performed on the input time signal for each time frame, time frequency distribution is obtained, tone likelihood distribution is obtained from the time frequency distribution, the likelihood distribution is smoothed in a frequency direction and a time direction, and the feature value per the predetermined time is extracted.

(9) A sound feature value extracting apparatus including: a time frequency transform unit which performs time frequency transform on an input time signal for each time frame and obtains time frequency distribution; a likelihood distribution detecting unit which obtains tone likelihood distribution from the time frequency distribution; and a feature value extracting unit which smooths the likelihood distribution in a frequency direction and a time direction and extracts a feature value per every predetermined time.

(10) The apparatus according to (9), wherein the likelihood distribution detecting unit includes a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result.

(11) The apparatus according to (9) or (10), further including: a thinning unit which thins out the smoothed likelihood distribution in the frequency direction and/or the time direction.

(12) The apparatus according to (9) or (10), further including: a quantizing unit which quantizes the smoothed likelihood distribution.

(13) The apparatus according to any one of (9) to (12), further including: a sound section detecting unit which detects a sound section based on the input time signal, wherein the likelihood distribution detecting unit obtains tone likelihood distribution from the time frequency distribution within a range of the detected sound section.

(14) The apparatus according to (13), wherein the sound section detecting unit includes a time frequency transform unit which performs time frequency transform on the input time signal for each time frame and obtains time frequency distribution, a feature value extracting unit which extracts feature value of amplitude, tone component intensity, and a spectrum approximate outline for each time frame based on the time frequency distribution, a scoring unit which obtains a score representing a sound section likeliness for each time frame based on the extracted feature values, a time smoothing unit which smooths the obtained score for each time frame in the time direction, and a threshold value determination unit which determinates a threshold value for the smoothed score for each time frame and obtains sound section information.

(15) A sound feature value extracting method including: obtaining time frequency distribution by performing time frequency transform on an input time signal for each time frame;

obtaining tone likelihood distribution from the time frequency distribution; and

smoothing the likelihood distribution in a frequency direction and a time direction.

(16) A sound section detecting apparatus including: a time frequency transform unit which obtains time frequency distribution by performing time frequency transform on an input time signal for each time frame; a feature value extracting unit which extracts feature values of amplitude, tone component intensity, and a spectrum approximate outline for each time frame based on the time frequency distribution; and a scoring unit which obtains a score representing sound section likeliness for each time frame based on the extracted feature values.

(17) The apparatus according to (16), further including: a time smoothing unit which smooths the obtained score for each time frame in the time direction; and a threshold value determination unit which determines a threshold for the smoothed score for each time frame and obtains sound section information.

(18) A sound section detecting method including: obtaining time frequency distribution by performing time frequency transform on an input time signal for each time frame; extracting feature values of amplitude, tone component intensity, and a spectrum approximate outline for each time frame based on the time frequency distribution; and obtaining a score representing sound section likeliness for each time frame based on the extracted feature values.

The present disclosure contains subject matter related to that disclosed in Japanese Priority Patent Application JP 2012-094395 filed in the Japan Patent Office on Apr. 18, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100: sound detecting apparatus

101: microphone

102: sound detecting unit

103: feature value database

104: recording and displaying unit

121: signal buffering unit

122: feature value extracting unit

123: feature value buffering unit

124: comparison unit

200: feature value registration apparatus

201: microphone

202: sound section detecting unit

203: feature value extracting unit

204: feature value registration unit

221: time frequency transform unit

222: amplitude feature value calculating unit

223: tone intensity feature value calculating unit

224: spectrum approximate outline feature value calculating unit

225: score calculating unit

226: time smoothing unit

227: threshold value determination unit

230: tone likelihood distribution detecting unit

231: peak detecting unit

232: fitting unit

233: feature value extracting unit

234: scoring unit

241: time frequency transform unit

242: tone likelihood distribution detecting unit

243: time frequency transform unit

244: thinning and quantizing unit

1. A sound detecting apparatus comprising:
a feature value extracting unit which extracts a feature value per every predetermined time from an input time signal;
a feature value maintaining unit which maintains a feature value sequence of a predetermined number of detection target sound items; and
a comparison unit which respectively compares a feature value sequence extracted by the feature value extracting unit with a feature value sequence of the maintained predetermined number of detecting target sound items and obtains detection results of the predetermined number of detection target sound items every time the feature value extracting unit newly extracts a feature value,
wherein the feature value extracting unit includes a time frequency transform unit which performs time frequency transform on the input time signal for each time frame and obtains time frequency distribution and a likelihood distribution detecting unit which obtains tone likelihood distribution from the time frequency distribution, smooths the obtained likelihood distribution in a frequency direction and a time direction, and extracts the feature value per the predetermined time.

2. The apparatus according to claim 1, wherein the likelihood distribution detecting unit includes a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result.

3. The apparatus according to claim 1, wherein the feature value extracting unit further includes a thinning unit which thins out the smoothed likelihood distribution in the frequency direction and/or the time direction.

4. The apparatus according to claim 1, wherein the feature value extracting unit further includes a quantizing unit which quantizes the smoothed likelihood distribution.

5. The apparatus according to claim 1, wherein the comparison unit obtains similarity based on correlation between corresponding feature values between the feature value sequence of the maintained detection target sound items and the feature value sequence extracted by the feature value extracting unit for each of the predetermined number of detection target sound items and obtains the detection results of the detection target sound items based on the obtained similarity.

6. The apparatus according to claim 1, further comprising:
a recording control unit which records the detection results of the predetermined number of detection target sound items along with time information on a recording medium.

7. A sound detecting method comprising:
extracting a feature value per every predetermined time from an input time signal; and
respectively comparing a feature value sequence extracted by the feature value extracting unit with a feature value sequence of the maintained predetermined number of detecting target sound items and obtaining detection results of the predetermined number of detection target sound items every time the feature value is newly extracted in the extracting of the feature value,
wherein in the extracting of the feature value, time frequency transform is performed on the input time signal for each time frame, time frequency distribution is obtained, tone likelihood distribution is obtained from the time frequency distribution, the likelihood distribution is smoothed in a frequency direction and a time direction, and the feature value per the predetermined time is extracted.

8. A program which causes a computer to perform:
extracting a feature value per every predetermined time from an input time signal; and
respectively comparing a feature value sequence extracted by the feature value extracting unit with a feature value sequence of the maintained predetermined number of detecting target sound items and obtaining detection results of the predetermined number of detection target sound items every time the feature value is newly extracted in the extracting of the feature value,
wherein in the extracting of the feature value, time frequency transform is performed on the input time signal for each time frame, time frequency distribution is obtained, tone likelihood distribution is obtained from the time frequency distribution, the likelihood distribution is smoothed in a frequency direction and a time direction, and the feature value per the predetermined time is extracted.

9. A sound feature value extracting apparatus comprising:
a time frequency transform unit which performs time frequency transform on an input time signal for each time frame and obtains time frequency distribution;
a likelihood distribution detecting unit which obtains tone likelihood distribution from the time frequency distribution; and
a feature value extracting unit which smooths the likelihood distribution in a frequency direction and a time direction and extracts a feature value per every predetermined time.

10. The apparatus according to claim 9, wherein the likelihood distribution detecting unit includes a peak detecting unit which detects a peak in the frequency direction in each time frame of the time frequency distribution, a fitting unit which fits the tone model at each detected peak, and a scoring unit which obtains a score representing tone component likeliness at each detected peak based on the fitting result.

11. The apparatus according to claim 9, further comprising:
a thinning unit which thins out the smoothed likelihood distribution in the frequency direction and/or the time direction.

12. The apparatus according to claim 9, further comprising:
a quantizing unit which quantizes the smoothed likelihood distribution.

13. The apparatus according to claim 9, further comprising:
a sound section detecting unit which detects a sound section based on the input time signal,
wherein the likelihood distribution detecting unit obtains tone likelihood distribution from the time frequency distribution within a range of the detected sound section.

14. The apparatus according to claim 13, wherein the sound section detecting unit includes a time frequency transform unit which performs time frequency transform on the input time signal for each time frame and obtains time frequency distribution, a feature value extracting unit which extracts feature value of amplitude, tone component intensity, and a spectrum approximate outline for each time frame based on the time frequency distribution, a scoring unit which obtains a score representing a sound section likeliness for each time frame based on the extracted feature values, a time smoothing unit which smooths the obtained score for each time frame in the time direction, and a threshold value determination unit which determinates a threshold value for the smoothed score for each time frame and obtains sound section information.

15. A sound feature value extracting method comprising:
obtaining time frequency distribution by performing time frequency transform on an input time signal for each time frame;
obtaining tone likelihood distribution from the time frequency distribution; and
smoothing the likelihood distribution in a frequency direction and a time direction.

16. A sound section detecting apparatus comprising:
a time frequency transform unit which obtains time frequency distribution by performing time frequency transform on an input time signal for each time frame;
a feature value extracting unit which extracts feature values of amplitude, tone component intensity, and a spectrum approximate outline for each time frame based on the time frequency distribution; and
a scoring unit which obtains a score representing sound section likeliness for each time frame based on the extracted feature values.

17. The apparatus according to claim 16, further comprising:
a time smoothing unit which smooths the obtained score for each time frame in the time direction; and
a threshold value determination unit which determines a threshold for the smoothed score for each time frame and obtains sound section information.

18. A sound section detecting method comprising:
obtaining time frequency distribution by performing time frequency transform on an input time signal for each time frame;
extracting feature values of amplitude, tone component intensity, and a spectrum approximate outline for each time frame based on the time frequency distribution; and
obtaining a score representing sound section likeliness for each time frame based on the extracted feature values.
